(19) United States
(12) Patent Application Publication
(10) Pub. No.: US 2017/0063628 A1
(43) Pub. Date: Mar. 2, 2017

(54) FUNCTION BINDING AND SELECTION IN A NETWORK

(71) Applicant: NOKIA SOLUTIONS AND NETWORKS OY, Espoo (FI)

(72) Inventor: Juha Antero RASANEN, Espoo (FI)

(73) Assignee: Nokia Solutions and Networks OY, Espoo (FI)

(21) Appl. No.: 15/307,623

(22) PCT Filed: Apr. 30, 2014
(86) PCT No.: PCT/EP2014/058792

§ 371 Date: Oct. 28, 2016

(51) Int. Cl. H04L 12/24; H04L 29/08

(52) U.S. Cl. CPC H04L 41/0893; H04L 41/0803; H04L 67/327

(57) ABSTRACT

It is provided a method, comprising configuring one or more instances of a first downstream network function (e.g. MME) such that each time when a first downstream transaction (e.g. a session establishment message) is requested from any of the one or more instances of the first downstream network function the respective instance of the first downstream network function requests a second downstream transaction from an instance of a predetermined group of one or more instances of a second downstream network function (e.g. a PCRF) to complete the first downstream transaction request; and prohibiting an apparatus performing the method from configuring the one or more instances of the first downstream network function such that any of the one or more instances of the first downstream network functions requests the second downstream transaction from an instance of the second downstream network function not belonging to the predetermined group. The method is applied in IMS and the evolved packet core.

### FIELD OF THE INVENTION

The present invention relates to an apparatus, a method, a system, and a computer program product related to communication networks. More particularly, the present invention relates to an apparatus, a method, a system, and a computer program product related to function binding.

### BACKGROUND OF THE INVENTION

### Abbreviations

3GPP 3^{rd} generation partnership project
APN Access point name
ARP Allocation and retention priority
ATM Asynchronous Transfer Mode
CDMA Code Division Multiple Access
CSCF Call Server Control Function
DPI Deep packet inspection
DRA Diameter routing agent
EDGE Enhanced Datarate for GSM Evolution
EPC Extended packet core
ETSI European Telecommunications Standards Institute
GGSN Gateway GPRS Support Node
GPRS Global Packet Radio Service
GS Group Specification
GW Gateway
HSS Home subscriber server
HW Hardware
I-CSCF Interrogating CSCF
IETF Internet engineering task force
IMS IP multimedia subsystem
IP Internet protocol
IP-CAN IP connectivity access network
ISG Industry specification group
LAN Local Area Network
LTE Long Term Evolution
LTE-A LTE Advanced
MANO Management and orchestration
MME Mobility management entity
NAT Network address translator
NFV Network function virtualization
NFVO Network function virtualization orchestrator
OCS Online charging system
OFCS Offline charging system
O&M Operations and maintenance
PCEF Policy and charging enforcement function
PCRF Policy and charging rules function
P-CSCF Proxy call server control function
PDN Packet data network
PLMN Public Land Mobile Network
PM Physical machine
P-GW Packet data network gateway
QCI QoS class identifier
QoS Quality of Service
S-CSCF Serving call server control function
S-GW Serving gateway
SA System Architecture
SW Software
TDFTraffic Detection Function
TS Technical Specification
UE User equipment
UTRAN Universal Terrestrial Radio Access Network
VM Virtual machine
VNF Virtualized network function
WAN Wide Area Network
WiFi Wireless Fidelity

A 3GPP mobile network contains a number of network entities that are selected from amongst a number of similar entities by other kinds of entities that need to establish communication with the first kind of entities to enable user sessions. In many cases at least one of the selection criteria is network topology. The addresses or identities of the candidate entities are typically configured in the entity that shall select one entity from the candidate entities.

An example is MME which is selected by a radio network entity, e.g. eNodeB. Further packet core network examples of entities selected by another entity are S-GW and SGSN (Refer to 3GPP TS 23.401/subclause 4.3.8). Examples of 3GPP network entities selected in such a way in IMS environment are P-CSCF which is selected by P-GW based on preconfigured P-CSCF addresses (refer to 3GPP TS 29.061/subclause 13a.2.1), S-CSCF which is selected by I-CSCF (refer to 3GPP TS 23.228/subclause 5.1.2.1). Further examples of entities selected from amongst a number of similar entities are PCRF and I-CSCF. The selection/discovery of PCRF even requires an extra functionality, DRA (Diameter routing agent), in the network in order to ensure that all control entities related to a given user session are able to contact the same PCRF.

The selection of a PCRF out of plural PCRF is illustrated in FIG. 1, taken from 3GPP TS 23.203. Different types of NEs (shown on the left side) may select a PCRF through their respective interface. In order to contact the PCRF assigned to the specific user, they have to contact first a DRA which is unique in its realm and which provides information which PCRF is to be contacted. As shown in FIG. 1, there may be several diameter realms in a network (PLMN).

ETSI ISG NFV is studying network function virtualization (NFV) concerning mobile network environment and has already produced a first set/release of Group Specifications (GS). The GSs deal e.g. with the NFV infrastructure architecture and NFV management and orchestration (NFVO). The NFVO can dynamically and automatically distribute and maintain virtualized network functions in the infrastructure, i.e. set up virtual machines (VMs) to run on given physical machines (PMs) and set up virtual network functions/entities to run on the VMs, and define, allocate and scale resources to the virtual entities and machines. The NVFO may also have an interface to legacy O&M functions to utilize existing O&M functionalities.

3GPP has also recently started working on applying network function virtualization to the 3GPP mobile network environment (refer to recent 3GPP TSG-SA1 meeting documents and reports). In a virtualized network the 3GPP mobile network entities and functionalities operate as virtual network function (VNF) instances on virtual machines on servers or server farms.

Relevant prior art is also disclosed in
3GPP TS 23.401 (especially subclause 4.3.8).
3GPP TS 29.061 (especially subclause 13a.2.1).
3GPP TS 23.228 (especially subclauses 5.1.2.1 and 5.1.3).
ETSI GS NFV-MAN 001 Network Function Virtualization (NFV) Management and Orchestration.
3GPP TSG-SA#65 meeting report and meeting documents: S1-140075, S1-140077, S1-140078, S1-140100, S1-140096, S1-140101, S1-140123.

### SUMMARY OF THE INVENTION

It is an object of the present invention to improve the prior art.

According to a first aspect of the invention, there is provided an apparatus, comprising configuring means adapted to configure one or more instances of a first downstream network function such that each time when a first downstream transaction is requested from any of the one or more instances of the first downstream network function the respective instance of the first downstream network function requests a second downstream transaction from an instance of a predetermined group of one or more instances of a second downstream network function to complete the first downstream transaction request; and prohibiting means adapted to prohibit the apparatus from configuring the one or more instances of the first downstream network function such that any of the one or more instances of the first downstream network functions requests the second downstream transaction from an instance of the second downstream network function not belonging to the predetermined group.

The configuring means may be adapted to configure in each instance of the first downstream network function, with respect to requesting the second downstream transaction, only identities of the instances of the predetermined group of the one or more instances of the second downstream network function.

The predetermined group may comprise only one instance of the second downstream network function. The second downstream network function may be a policy and charging rules function.

The first downstream network function may reside on a different plane than the second downstream network function.

According to a second aspect of the invention, there is provided an apparatus, comprising configuring circuitry configured to configure one or more instances of a first downstream network function such that each time when a first downstream transaction is requested from any of the one or more instances of the first downstream network function the respective instance of the first downstream network function requests a second downstream transaction from an instance of a predetermined group of one or more instances of a second downstream network function to complete the first downstream transaction request; and prohibiting circuitry configured to prohibit the apparatus from configuring the one or more instances of the first downstream network function such that any of the one or more instances of the first downstream network functions requests the second downstream transaction from an instance of the second downstream network function not belonging to the predetermined group.

The configuring circuitry may be configured to configure in each instance of the first downstream network function, with respect to requesting the second downstream transaction, only identities of the instances of the predetermined group of the one or more instances of the second downstream network function.

The predetermined group may comprise only one instance of the second downstream network function. The second downstream network function may be a policy and charging rules function.

The first downstream network function may reside on a different plane than the second downstream network function.

According to a third aspect of the invention, there is provided an apparatus, comprising first configuring means adapted to configure one or more instances of an initiating network function such that each time when a first initiating transaction is requested from any of the instances of the initiating network function the respective instance of the initiating network function requests a downstream transaction from an instance of a predefined group of one or more instances of a downstream network function, and alternative configuring means adapted to configure the one or more instances of the initiating network function such that each time when a second initiating transaction different from the first initiating transaction is requested from any of the instances of the initiating network function the respective instance of the initiating network function requests the downstream transaction from an instance of the downstream network function not belonging to the predefined group.

The first initiating transaction may be different from the second initiating transaction by at least one of an access point name, a subscription information, and a requested quality of service.

The predefined group of one or more instances of the downstream network function may comprise only one instance. The downstream network function may be a policy and charging rules function. The initiating network function may reside on a different plane than the downstream network function.

According to a fourth aspect of the invention, there is provided an apparatus, comprising first configuring circuitry configured to configure one or more instances of an initiating network function such that each time when a first initiating transaction is requested from any of the instances of the initiating network function the respective instance of the initiating network function requests a downstream transaction from an instance of a predefined group of one or more instances of a downstream network function, and alternative configuring circuitry configured to configure the one or more instances of the initiating network function such that each time when a second initiating transaction different from the first initiating transaction is requested from any of the instances of the initiating network function the respective instance of the initiating network function requests the downstream transaction from an instance of the downstream network function not belonging to the predefined group.

The first initiating transaction may be different from the second initiating transaction by at least one of an access point name, a subscription information, and a requested quality of service.

The predefined group of one or more instances of the downstream network function may comprise only one instance. The downstream network function may be a policy and charging rules function. The initiating network function may reside on a different plane than the downstream network function.

According to a fifth aspect of the invention, there is provided a system, comprising an initiation managing apparatus according to any of the third and fourth aspects; and a downstream managing apparatus according to any of the first and second aspects; wherein the first downstream network function of the downstream managing apparatus comprises the downstream network function of the initiation managing apparatus; the one or more instances of the first downstream network function of the downstream managing apparatus comprise the first group of the one or more instances of the downstream network function of the initiation managing network; and the first downstream transaction of the downstream managing apparatus comprises the downstream transaction of the initiation managing apparatus.

According to a sixth aspect of the invention, there is provided an apparatus, comprising requesting means adapted to request a second transaction from an instance of a predetermined group of instances of a downstream network function each time when a first transaction is requested from the apparatus; and inhibiting means adapted to inhibit the apparatus from requesting the second transaction from an instance of the downstream network function not belonging to the predetermined group.

The apparatus may further comprise memory means configured to store, as an identity where the second transaction may be requested, only identities of the instances of the predetermined group.

According to a seventh aspect of the invention, there is provided an apparatus, comprising requesting circuitry configured to request a second transaction from an instance of a predetermined group of instances of a downstream network function each time when a first transaction is requested from the apparatus; and inhibiting circuitry configured to inhibit the apparatus from requesting the second transaction from an instance of the downstream network function not belonging to the predetermined group.

The apparatus may further comprise memory circuitry configured to store, as an identity where the second transaction may be requested, only identities of the instances of the predetermined group.

According to an eighth aspect of the invention, there is provided an apparatus, comprising first selecting means adapted to select a predetermined group of instances of a downstream network function each time when a first initiating transaction is requested from the apparatus; alternative selecting means adapted to select an alternative instance of the downstream network function not belonging to the predetermined group each time when a second initiating transaction different from the first initiating transaction is requested from the apparatus; requesting means adapted to request a downstream transaction from an instance of the predetermined group if the first initiating transaction is requested in order to complete the first initiating transaction and to request the downstream transaction from the alternative instance if the second initiating transaction is requested in order to complete the second initiating transaction.

The first initiating transaction may be different from the second initiating transaction by at least one of an access point name, a subscription information, and a requested quality of service.

According to an ninth aspect of the invention, there is provided an apparatus, comprising first selecting circuitry configured to select a predetermined group of instances of a downstream network function each time when a first initiating transaction is requested from the apparatus; alternative selecting circuitry configured to select an alternative instance of the downstream network function not belonging to the predetermined group each time when a second initiating transaction different from the first initiating transaction is requested from the apparatus; requesting circuitry configured to request a downstream transaction from an instance of the predetermined group if the first initiating transaction is requested in order to complete the first initiating transaction and to request the downstream transaction from the alternative instance if the second initiating transaction is requested in order to complete the second initiating transaction.

The first initiating transaction may be different from the second initiating transaction by at least one of an access point name, a subscription information, and a requested quality of service.

In the apparatus according to any of the sixth to ninth aspects, the predetermined group of instances of the downstream network function may comprise only one instance. In the apparatus according to any of the sixth to ninth aspects, the downstream network function may be a policy and charging rules function. In the apparatus according to any of the sixth to ninth aspects, the downstream network function may reside on a different plane than the apparatus. The apparatus according to any of the sixth to ninth aspects may be configured as a virtual network element.

According to a tenth aspect of the invention, there is provided a system, comprising one or more initiating apparatuses according to any of the eighth and ninth aspects; and one or more downstream apparatuses according to any of the sixth and seventh aspects; wherein each of the downstream apparatuses comprises an instance of the first group of instances of the downstream network function of each of the initiating apparatuses; the requesting means and requesting circuitry, respectively, of each of the initiating apparatuses are adapted and configured, respectively, to request the same downstream transaction if the first initiating transaction is requested; and the downstream transaction requested by each of the initiating apparatuses comprises the first transaction requested from each of the downstream apparatuses.

According to an eleventh aspect of the invention, there is provided a method, comprising configuring one or more instances of a first downstream network function such that each time when a first downstream transaction is requested from any of the one or more instances of the first downstream network function the respective instance of the first downstream network function requests a second downstream transaction from an instance of a predetermined group of one or more instances of a second downstream network function to complete the first downstream transaction request; and prohibiting an apparatus performing the method from configuring the one or more instances of the first downstream network function such that any of the one or more instances of the first downstream network functions requests the second downstream transaction from an instance of the second downstream network function not belonging to the predetermined group.

The configuring may comprise configuring in each instance of the first downstream network function, with respect to requesting the second downstream transaction, only identities of the instances of the predetermined group of the one or more instances of the second downstream network function.

The predetermined group may comprise only one instance of the second downstream network function. The second downstream network function may be a policy and charging rules function. The first downstream network function may reside on a different plane than the second downstream network function

According to a twelfth aspect of the invention, there is provided a method, comprising configuring one or more instances of an initiating network function such that each time when a first initiating transaction is requested from any of the instances of the initiating network function the respective instance of the initiating network function requests a downstream transaction from an instance of a predefined group of one or more instances of a downstream network function, and configuring the one or more instances of the initiating network function such that each time when a second initiating transaction different from the first initiating transaction is requested from any of the instances of the initiating network function the respective instance of the initiating network function requests the downstream transaction from an instance of the downstream network function not belonging to the predefined group.

The first initiating transaction may be different from the second initiating transaction by at least one of an access point name, a subscription information, and a requested quality of service.

The predefined group of one or more instances of the downstream network function may comprise only one instance. The downstream network function may be a policy and charging rules function. The initiating network function may reside on a different plane than the downstream network function.

According to a thirteenth aspect of the invention, there is provided a method, comprising requesting a second transaction from an instance of a predetermined group of instances of a downstream network function each time when a first transaction is requested from an apparatus performing the method; and inhibiting the apparatus from requesting the second transaction from an instance of the downstream network function not belonging to the predetermined group.

The method may further comprise storing, as an identity where the second transaction may be requested, only identities of the instances of the predetermined group.

According to a fourteenth aspect of the invention, there is provided a method, comprising selecting a predetermined group of instances of a downstream network function each time when a first initiating transaction is requested from an apparatus performing the method; selecting an alternative instance of the downstream network function not belonging to the predetermined group each time when a second initiating transaction different from the first initiating transaction is requested from the apparatus; requesting a downstream transaction from an instance of the predetermined group if the first initiating transaction is requested in order to complete the first initiating transaction and to request the downstream transaction from the alternative instance if the second initiating transaction is requested in order to complete the second initiating transaction.

The first initiating transaction may be different from the second initiating transaction by at least one of an access point name, a subscription information, and a requested quality of service.

In the method according to any of the thirteenth and fourteenth aspects, the predetermined group of instances of the downstream network function may comprise only one instance. In the method according to any of the thirteenth and fourteenth aspects, the downstream network function may be a policy and charging rules function. In the method according to any of the thirteenth and fourteenth aspects, the downstream network function may reside on a different plane than the apparatus.

The method according to each of the eleventh to fourteenth aspects may be a method of function binding.

According to a fifteenth aspect of the invention, there is provided a computer program product comprising a set of instructions which, when executed on an apparatus, is configured to cause the apparatus to carry out the method according to any of the eleventh to fourteenth aspects. The computer program product may be embodied as a computer-readable medium or directly loadable into a computer.

According to some embodiments of the invention, at least one of the following advantages may be achieved:
The selection and discovery mechanism is efficient;
The selection and discovery mechanism can cope with different identifiers used in different planes or domains;
Redundant selection steps are avoided;
Load balancing need not to be involved in the selection step;
Capabilities of network virtualization such as load balancing may be exploited for a 3GPP network;
Performance of the network elements for call/session processing is enhanced;
Scaling out/in of an entity is supported efficiently;
Uniqueness of certain network functions (like PCRF for a user) may be achieved;
A diameter routing agent is not required in the PCRF selection process;
Interfaces between network elements (network functions) need not to be modified; and
The solution is backwards compatible.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a conventional PCRF selection, taken from 3GPP TS 23.203, FIGS. 7.6-1;

FIG. 2 shows an architecture of a 3GPP network, taken from 3GPP TS 23. 401, FIG. 4.2.1-1;

FIG. 3 shows a session chain according to an embodiment of the invention;

FIG. 4 shows a message flow according to an embodiment of the invention;

FIG. 5 shows a session chain according to an embodiment of the invention;

FIG. 6 shows an apparatus according to an embodiment of the invention;

FIG. 7 shows a method according to an embodiment of the invention;

FIG. 8 shows an apparatus according to an embodiment of the invention;

FIG. 9 shows a method according to an embodiment of the invention;

FIG. 10 shows an apparatus according to an embodiment of the invention;

FIG. 11 shows a method according to an embodiment of the invention;

FIG. 12 shows an apparatus according to an embodiment of the invention;

FIG. 13 shows a method according to an embodiment of the invention; and

FIG. 14 shows an apparatus according to an embodiment of the invention.

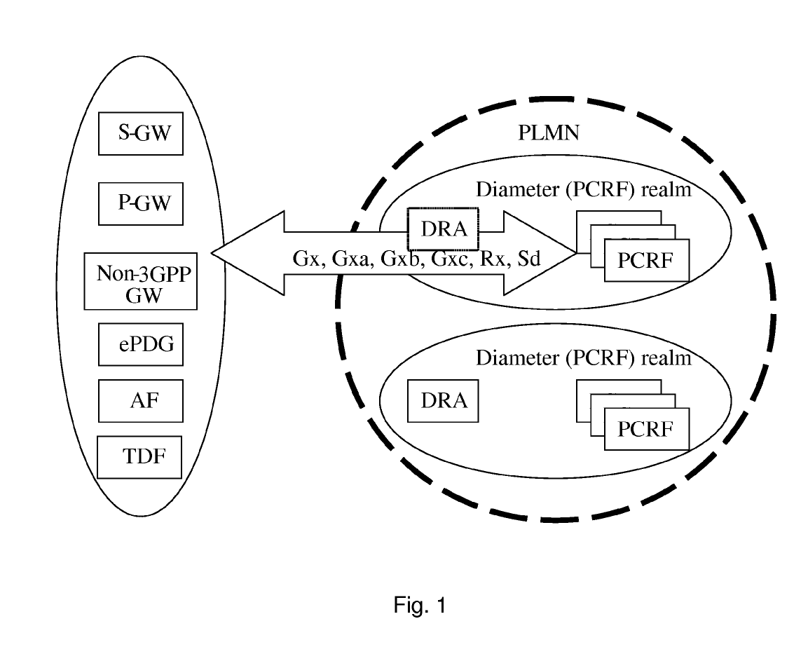

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

In a virtualized telecommunication environment like the 3GPP mobile network used as an example here, the network entity selection and discovery mechanism currently used in 3GPP specifications may turn out to be awkward and inefficient or even unusable. The mechanism is based pretty much on semi-permanent configurations on each selecting entity, i.e. a selecting entity has got a list of next entities to choose from (“to-be-selectable”). Each selecting network entity has some kind of a decision logic and procedure for selecting the next entity and runs that procedure every time the next entity is needed for an IP-CAN session or for a user or application session. A load balancer may also be involved/needed for each selection mechanism/process.

One of the virtues of the NFV environment is the dynamic adjustment of resources available in the network to meet the present needs by the applications, which makes the use of semi-permanent configurations for entity selection at least very difficult, if not impossible. In other words, scaling out/in (out/in meaning adding/reducing the number of instances of an entity) is pretty awkward, if not impossible with semi-permanent configurations.

A further complication in the current 3GPP entity selection/discovery mechanisms is the need to use an extra functionality, DRA, for the discovery of the correct PCRF. As discussed hereinabove, all control entities (which may mean e.g. S-GW, P-GW, P-CSCF) related to a user session should be bound to the same PCRF. Extra message exchange is needed between the PCRF searching entities (e.g. S-GW, P-GW, P-CSCF) and the DRA to find the correct PCRF.

A further issue is that different planes may use different user identifiers not necessarily bound together in any way, i.e. they may be mutually independent. An example of this in 3GPP specifications is the IMS user identities used on the IMS signalling plane versus the user identities used on EPC, i.e. on the bearer/user plane. In certain conditions the independence of the identities may complicate the PCRF selection and discovery process.

Some embodiments of the invention use the concept of a “dependency chain”. It is defined as follows:
A dependency chain indicates a dependency between instances of different functions in a network.
The functions may reside on the same plane (e.g. bearer plane, also named user plane) or on different planes (e.g. on signalling plane, control plane and/or bearer/user plane).
The dependency chain concept aims at steering (or routing) all flows or events or transactions that are allowed to enter the chain through instances of a same group of entities or functions of the chain on a particular plane or even between planes, i.e. a dependency chain is independent of services or service data flows.
When different planes are involved in a dependency chain (e.g. signalling plane, control plane and/or bearer/user plane), the dependency chain concept may steer/route different events or transactions taking place on different planes (e.g. on signalling plane and bearer/user plane) to meet or interact on a common instance of a function or on a common group of instances of a function which again may reside on a different planes (e.g. control plane) or on one of the event/transaction originating planes.

The terms “event” and transaction” may be used synonymously in the context of the application if not otherwise indicated. For example, session establishment is an example of a transaction which comprises a transaction request to establish a session and a transaction response that the session is established.

Also, the terms “entity” and “function” may be used synonymously in the context of the application if not otherwise indicated. Typically, an entity may have some underlying hardware, whereas a “function” may be purely SW based. However, within the present application, these terms must not be understood as restricted in that or another way.

According to embodiments of the invention, a network management and/or control functionality, e.g. the network function virtualization orchestrator (NFVO) as per the ETSI ISG NFV Group Specifications, configures the network entity selection parameters on network entities that need to select the next entity. The parameters may comprise e.g. an identity such as the address of the next network entity. The parameters may be different for different planes, e.g. control plane and user plane. The parameters may also be the same on different planes, e.g. on signalling plane and on bearer/user plane, thus effectively letting entities on different planes to select a common next entity for events or transactions. The network management and/or control functionality may dynamically maintain the configurations according to the currently active network entities and/or instances.

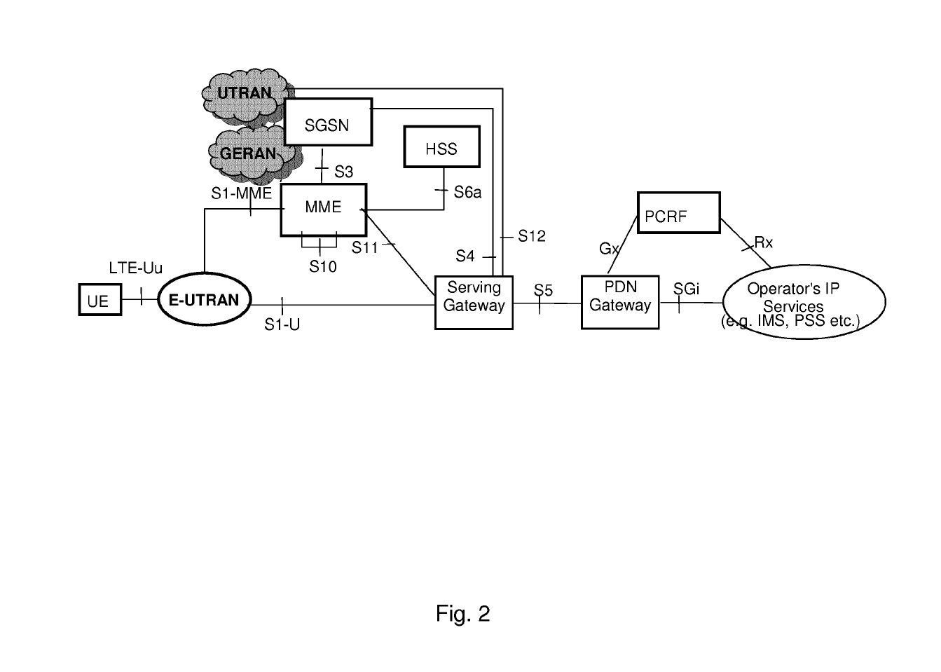

According to embodiments of the invention, dependencies are defined between network entity types that are needed under given conditions/circumstances or for given session types. Subsequent dependencies may be called a “dependency chain”, as mentioned hereinabove, or in the particular case of establishment of sessions as transaction, a “session chain”. For example, an IP-CAN session with a certain PDN type or APN indicated in the attach procedure may need, in addition to the radio network (E-UTRAN), an MME, S-GW, P-GW/PCEF, PCRF and TDF with respective sessions. A corresponding architecture (without TDF) is shown in FIG. 2 taken from 3GPP TS 23.401.

As another example, an IP-CAN session with the APN type IMS indicated in the attach procedure may need, in addition to the radio network, an MME, S-GW, P-GW/PCEF, PCRF, P-CSCF and S-CSCF with respective sessions. The dependencies (session chains) may be created within the network management and/or control functionality and may be used for configuring the network entity selection parameters on network entities that need to select the next entity.

Each dependency chain may comprise a first network function (network element) which selects the dependency chain, and one or more subsequent network functions (network elements) within the dependency chain.

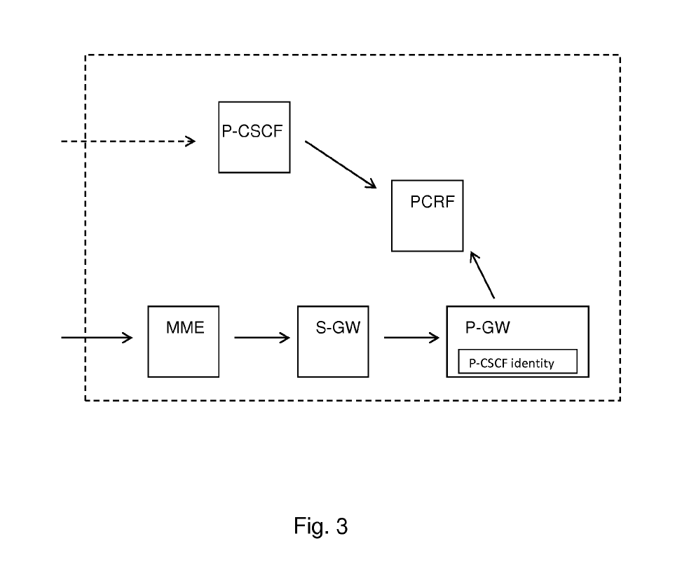

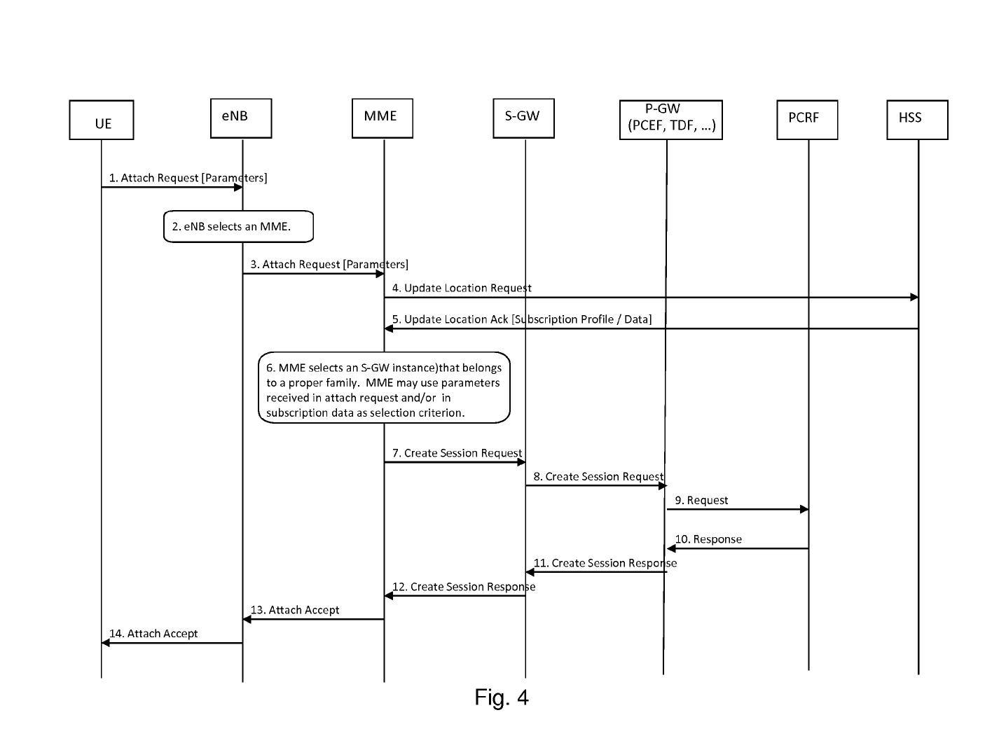

The session chain shown in FIG. 3, which is an embodiment of the invention, is based on the architecture of FIG. 2. A session setup flow of this session chain is shown in FIG. 4.

In FIG. 3, MME is the first network function, also named initiating network function. Based on diverse parameters such as APN, QoS, subscription information etc., for an IP-CAN session MME selects one of the one or more dependency chains which are preconfigured in the MME by the management function or control function such as a NFVO (not shown).

The Access Point Name (APN) typically defines in which PLMN GPRS/EPS backbone the GGSN/PGW is located and to which external network the GGSN/PGW is connected. When attaching the network and establishing a default context/session, a UE may request a certain APN, typically to be able to access certain services and/or external networks. The network may use the APN for deducing which planes (e.g. signaling, control and/or user plane) are needed for the connection to support user sessions and which types of functions on each plane are needed for the connection and select a dependency chain or dependency chains accordingly.

QoS and/or subscription information may also be used for selecting a dependency chain or dependency chains. For example ARP or QCI, or the priority of the user defined in the subscription profile, may be used for selecting a given dependency chain e.g. from amongst other similar dependency chains e.g. to offer a higher quality or priority operation/service for the user/UE, or e.g. to separate certain types of users/UEs, e.g. machine type communication, from other users/UEs and be served by different network entities.

The dependency chain in FIG. 3 comprises S-GW, PGW, and PCRF as subsequent network functions, also named downstream network functions. According to FIG. 3, there is one instance of each downstream network functions in the dependency chain. Thus, by selecting the dependency chain, S-GW, P-GW, and PCRF are unambiguously defined. There is a 1:N (N≧1) relationship between MME and SGW(s) because MME may select one out of potentially plural (N) dependency chains. For each chain, there are 1:1 relationships between MME and S-GW, between S-GW and P-GW, and between P-GW and PCRF.

FIG. 4 shows a message flow according to an embodiment of the invention corresponding to the session chain shown in FIG. 3. Before the message flow takes place, instances of dependency chains were created and related parameters were configured in the relevant instances of network entities. The message flow is as follows:
1. UE attaches the network.
2. eNB selects an MME.
3. eNB sends the Attach request further to the selected MME.
4. MME sends an Update Location Request message to HSS.
5. HSS responds with an Update Location Ack message that includes the user's subscription data/subscription profile.
6. MME selects an S-GW instance that belongs to a proper session chain (also named family). MME may use parameters received in attach request and/or in the subscription data/profile as selection criterion, i.e. a certain combination of the parameters may point to the identity (e.g. address) of a certain S-GW instance.
7. MME sends a Create Session Request message to the selected S-GW instance.
8. The S-GW instance knows the P-GW instance of the same session chain by the configuration (made earlier and maintained by the network management and/or control functionality) because it stores only an identity of the P-GW of this session chain and no other P-GW identity (as an allowed P-GW instance). I.e., S-GW does not need to select between different P-GWs. Thus, S-GW sends the Create Session Request message further to the predefined P-GW instance.
9. The P-GW instance knows the PCRF instance of the same session chain by the configuration (made earlier and maintained by the network management and/or control functionality) because it stores only an identity of the PCRF of this session chain and no other PCRF identity (as an allowed PCRF instance). I.e., P-GW does not need to select between different PCRF instances, and P-GW does not need to inquire a DRA to identify the correct PCRF instance. Thus, P-GW sends a Request message to the predefined PCRF instance.
10. From step 10 onwards the scenario comprises response messages.

The instance of a session chain according to FIG. 3 includes an instance of each of an S-GW, P-GW and PCRF. In some embodiments, the session chain may further include instances of e.g. PCEF, TDF or any other functionality such as DPI, firewall, NAT, OCS, OFCS, etc. In some other embodiments, the session chain may not comprise some or all of the network functionalities shown in FIG. 3 but other network functionalities instead.

FIG. 3 shows additionally P-CSCF which is required for an UE attaching to an IMS APN and which needs to contact for each user the same PCRF as for the case of an IP-CAN session discussed hereinabove. Thus, the session chain according to embodiments of the invention may also comprise IMS signalling plane entities. Referring to FIG. 3, a dependency chain to be selected (in this example by MME) upon the attach procedure may contain also instances of IMS signalling plane entities, e.g. an instance of P-CSCF, and an instance of S-CSCF. The UE may get the P-CSCF address/identity from the P-GW in a message as per current specifications, but the address/identity refer in this case to the P-CSCF instance belonging to the dependency chain. This is ensured because the P-GW from which the P-CSCF identity is retrieved belongs to the dependency chain and stores only the identity of the P-CSCF of this dependency chain as an allowed P-CSCF. Similar to the P-GW, P-CSCF stores only one identity of an allowed PCRF (i.e. an identity of the same PCRF whose identity is stored by the P-GW of the session chain), wherein the PCRF identity stored by P-CSCF is configured (predefined) by the network management and/or control functionality. The operating principle may otherwise be the same as described above. For example, when the P-CSCF needs to discover and contact the PCRF (typically upon the UE registration to IMS) used by the user/UE session, the P-CSCF instance knows the only allowed PCRF instance (of the same chain) by the configuration and contacts the same. This mechanism effectively binds an instance or instances of the P-CSCF function on the IMS signalling plane with an instance or instances of the P-GW function on the bearer/user plane by directing the instances of these functions to use the same PCRF entity or the same instance of a PCRF.

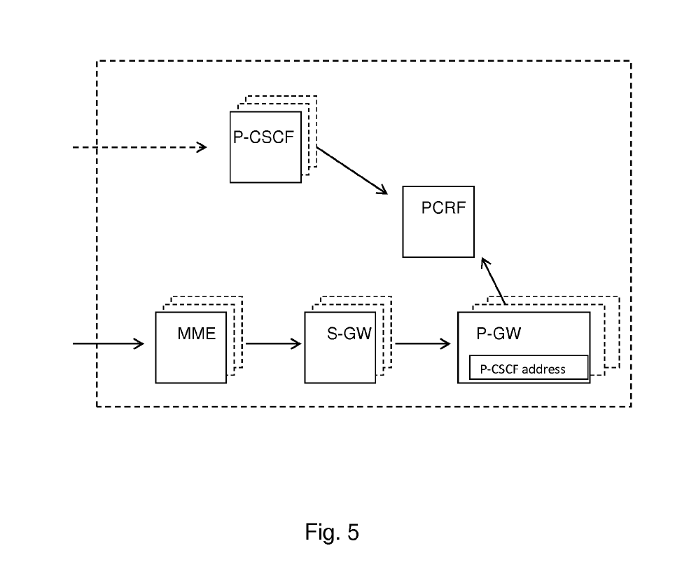

In FIG. 3, there is one instance of each network function. However, each chain may comprise more than one instance of some or all of its network functions. An embodiment corresponding to that of FIG. 3 is shown in FIG. 5. In this embodiment, there are several instances of MME, S-GW, P-GW, and P-CSCF. The number of instances of each function may (dynamically) depend on and/or change due to e.g. scale out/scale in operations for resource adjustments in the network.

The several instances of each network function may be considered as a group of instances. Thus, the message flow of FIG. 4 may be adapted such that each time, when a network function selects or determines a subsequent network function, the corresponding description is replaced such that the network function (or the instance of the network function) selects or determines an instance from a group of predefined instances of the subsequent network function.

In detail, in an embodiment of the invention, the following steps of FIG. 4 may be modified for the dependency chain shown in FIG. 5 (the modified steps are marked by prime, the other steps of FIG. 4 are not modified):
6′. MME selects a group of S-GW instances that belongs to a proper dependency chain, i.e. selects a dependency chain. MME may use parameters received in attach request and/or in the subscription data/profile as selection criterion, i.e. a certain combination of the parameters may point to a group of identities (e.g. addresses) of a certain S-GW instances. Then it selects one of the S-GW instances of the group e.g. based on load balancing and/or network topology considerations.
7′. MME sends a Create Session Request message to the selected S-GW instance which is one of the predefined S-GW instances.
8′. The S-GW instance knows the group of P-GW instances of the same session chain by the configuration (made earlier and maintained by the network management and/or control functionality) because it stores only identities of the group of P-GW instances of this session chain and no other P-GW identity (as an allowed P-GW instance). Then, S-GW selects one of the P-GW instances of the group, e.g. based on load balancing and/or network topology considerations. Thus, S-GW sends the Create Session Request message further to one of the predefined P-GW instances.

All instances of a same network function of a session chain are configured by the same parameters with respect to a subsequent (downstream) network function. That is, each instance of a former network function (e.g. each S-GW instance) of the session chain comprises the identities of the same instances of the subsequent (downstream) network function (e.g. P-GW instances). This is ensured by the configuration made by the network management and/or control function.

In the embodiments of FIGS. 3 and 5, there is only one PCRF instance. I.e., all P-GW instances and all P-CSCF instances of the session chain store an identity of only this one PCRF instance as an allowed PCRF instance. Thus, together with the same configurations in all instances of each network function, it is ensured that each session request for which this session chain is selected by MME finally reaches this one PCRF, regardless of which of the instances of the MME is selected by the radio network and which of the instances of the group of instances predefined in the downstream network functions (S-GW, P-GW) is selected by the respective preceding network function.

Different session chain instances may be created based on different IP-CAN session parameters like e.g. the APN or PDN type, and/or on different user profiles available in the network. In other words, a certain combination of the parameters may point to the identity (e.g. address) of a certain instance of a downstream network entity to be selected or to a group of such instances. A network entity having access to the parameters selects the next entity accordingly (as per configuration made by the network management and/or control functionality), i.e. selects an instance of a downstream network function of a proper chain, and consequently the whole chain is selected (except that there may be different but identically configured (with respect to the subsequent network function) instances of some network functions of the chain). For example, an MME checks the parameters of an Attach Request and the user profile received from HSS and selects an S-GW instance accordingly.

As a consequence, in some embodiments of the invention, instances of different groups of instances of a same network function belonging to different session chains may not overlap. That is, if an instance of a network function belongs to a certain session chain (or another type of dependency chain), it does not belong to any other session chain (or another dependency chain of the same type). The network management and/or control function may have to take care that the identities stored (as allowed instances) in the instances of a preceding network function are appropriately configured.

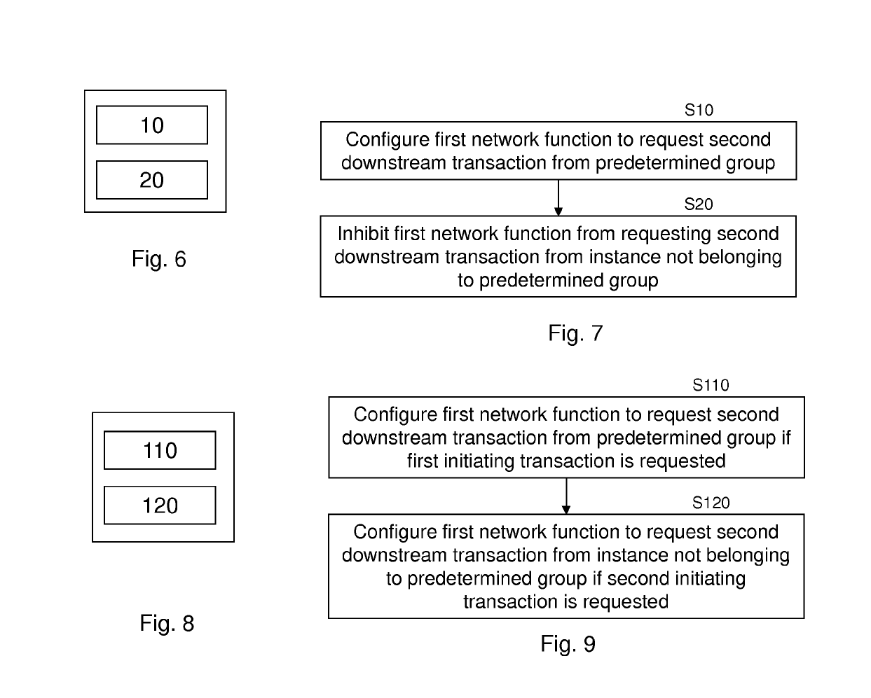

FIG. 6 shows an apparatus according to an embodiment of the invention. The apparatus may be a network management function and/or a control function such as an NFVO, or an element thereof. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises configuring means 10 and prohibiting means 20.

The configuring means 10 configures one or more instances of a first downstream network function such as a PGW in FIG. 3 (S10). The configuring means 10 configures the instances of the first downstream network function such that each time when a first downstream transaction is requested from any of these instances the respective instance requests a second downstream transaction from an instance of a predetermined group of one or more instances of a second downstream network function to fulfill the first downstream transaction request. An example of the second downstream network function is PCRF in FIG. 3. The predetermined group may comprise only one instance. An example of a transaction is a session establishment.

The prohibiting means 20 prohibits the apparatus from configuring the one or more instances of the first downstream network function such that any of these instances requests the second downstream transaction from an instance of the second downstream network function not belonging to the predetermined group (S20). I.e., the configuring means has to configure the instances of the first downstream network functions belonging to a certain dependency chain such that they do not have a choice to request the second downstream transaction from an instance not belonging to the predetermined group.

The sequence of steps S10 and S20 may be interchanged. Steps S10 and S20 may be performed in parallel.

FIG. 8 shows an apparatus according to an embodiment of the invention. The apparatus may be a network management function and/or a control function such as an NFVO, or an element thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises first configuring means 110 and alternative configuring means 120.

The first configuring means 110 configures one or more instances of an initiating network function such as an MME in FIG. 3 (S110). The first configuring means configures these instances such that each time when a first initiating transaction is requested from any of these instances the respective instance requests a first downstream transaction from an instance of a predefined group of one or more instances of a downstream network function. An example of such a downstream network function is SGW in FIG. 3. An example of a transaction is a session establishment.

The alternative configuring means 120 configures the one or more instances of the initiating network function, too (S120). The alternative configuring means 120 configures these instances such that each time when a second initiating transaction different from the first initiating transaction is requested from any of these instances the respective instance requests the first downstream transaction from an instance of the downstream network function not belonging to the predefined group. An SGW different from the one of FIG. 3 is an example of an instance of the alternative group.

The sequence of steps S110 and S120 may be interchanged. Steps S110 and S120 may be performed in parallel.

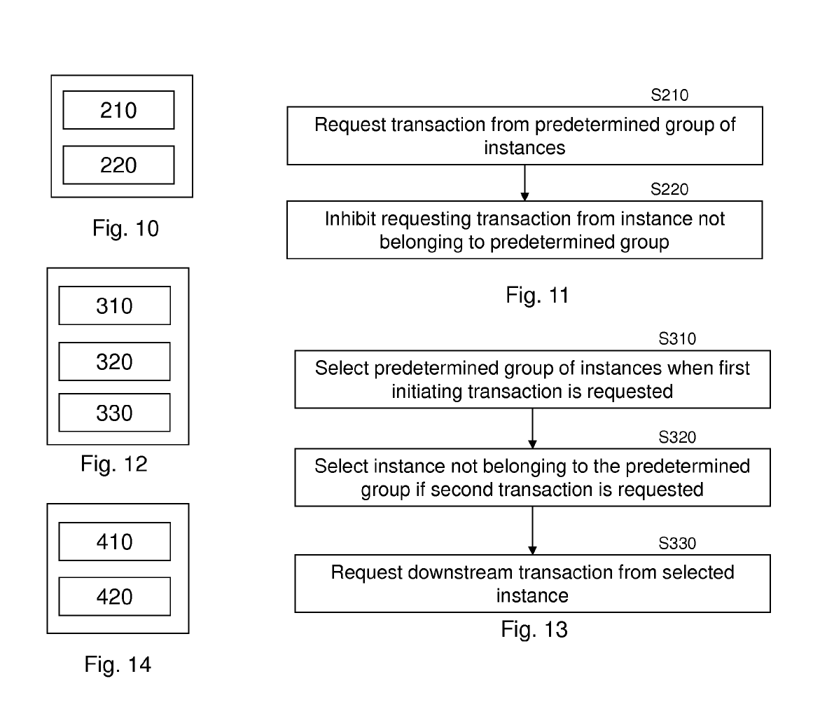

FIG. 10 shows an apparatus according to an embodiment of the invention. The apparatus may be a network function and/or a network element such as a virtual network element, or an element thereof. FIG. 11 shows a method according to an embodiment of the invention. The apparatus according to FIG. 10 may perform the method of FIG. 11 but is not limited to this method. The method of FIG. 11 may be performed by the apparatus of FIG. 10 but is not limited to being performed by this apparatus. An example of such an apparatus is each of S-GW, P-GW, and P-CSCF of FIG. 3.

The apparatus comprises requesting means 210 and inhibiting means 220.

The requesting means 210 requests a second transaction from an instance of a predetermined group of instances of a downstream network function each time when a first transaction is requested from the apparatus (S210). An example of a transaction is a session establishment.

The inhibiting means 220 inhibits the apparatus from requesting the second transaction from an instance of the downstream network function not belonging to the predetermined group (S220). Thus, the apparatus does not have a choice to request the second transaction from an instance not belonging to the predetermined group.

The sequence of steps S210 and S220 may be interchanged. Steps S210 and S220 may be performed in parallel.

FIG. 12 shows an apparatus according to an embodiment of the invention. The apparatus may be a network function and/or a network element such as a virtual network element, or an element thereof. FIG. 13 shows a method according to an embodiment of the invention. The apparatus according to FIG. 12 may perform the method of FIG. 13 but is not limited to this method. The method of FIG. 13 may be performed by the apparatus of FIG. 12 but is not limited to being performed by this apparatus. An example of such an apparatus is MME of FIG. 3.

The apparatus comprises first selecting means 310, alternative selecting means 320, and requesting means 330.

The first selecting means 310 selects a predetermined group of instances of a downstream network function (such as S-GW in FIG. 3) each time when a first initiating transaction is requested from the apparatus (S310).

The alternative selecting means 320 selects an alternative instance of the downstream network function not belonging to the predetermined group each time when a second initiating transaction different from the first initiating transaction is requested from the apparatus (S320). An example of a transaction is a session establishment.

The sequence of steps S310 and S320 may be interchanged. Steps S310 and S320 may be performed in parallel.

The requesting means 330 requests a downstream transaction from an instance of the predetermined group if the first initiating transaction is requested in order to complete the first initiating transaction and requests the downstream transaction from the alternative instance if the second initiating transaction is requested in order to complete the second initiating transaction (S330).

FIG. 14 shows an apparatus according to an embodiment of the invention. The apparatus comprises at least one processor 410, at least one memory 420 including computer program code, and the at least one processor, with the at least one memory and the computer program code, being arranged to cause the apparatus to at least perform at least one of the methods according to FIGS. 7, 9, 11, and 13.

The number of network functionalities in a dependency chain is not limited but may be any number equal to or larger than 2.

If the present application refers to a session chain, it is to be considered as an example of a dependency chain. The same mechanisms may apply to other transactions than establishing a session.

Embodiments of the invention may be employed in an LTE network. They may be employed also in other mobile communication networks such as CDMA, EDGE, UTRAN, LTE-A, WiFi networks, etc., and also in fixed communication networks such as ATM networks, LAN, WAN, etc.

A terminal may be a user equipment such as a mobile phone, a smart phone, a PDA, a laptop, a tablet PC, or any other device which may be connected to the respective mobile network.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

Instead of the term “network element” or “network entity”, sometimes the term “network function” is used. These terms are considered to be synonymous unless otherwise stated. By the term “network function”, it is emphasized that the functionality of a network element may be provided purely based on SW without any dedicated underlying HW (such as in a case of network virtualization). However, the expression “network function” is not to be understood as restricted to a purely SW based implementation, and the expressions “network element” or “network entity” are not to be understood as restricted to having an underlying dedicated HW.

If not otherwise stated or otherwise made clear from the context, the statement that two entities are different means that they perform different functions. It does not necessarily mean that they are based on different hardware (if they are based on a hardware). That is, each of the entities described in the present description may be based on a different hardware, or some or all of the entities may be based on the same hardware. It does not necessarily mean that they are based on different software (if they are based on a software). That is, each of the entities described in the present description may be based on different software, or some or all of the entities may be based on the same software. It does not necessarily mean that they are based on different virtual machines (if they are based on a virtual machine). That is, each of the entities described in the present description may be based on different VMs, or some or all of the entities may be based on the same VM.

According to the above description, it should thus be apparent that exemplary embodiments of the present invention provide, for example a network element, e.g. a MME, A S-GW, a P-GW, a PCRF, a P-CSCF, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that exemplary embodiments of the present invention provide, for example a control unit or a management entity, e.g. a NFVO, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1.-39. (canceled)

40. Apparatus, comprising:
first configuring means adapted to configure one or more instances of an initiating network function such that each time when a first initiating transaction is requested from any of the instances of the initiating network function the respective instance of the initiating network function requests a downstream transaction from an instance of a predefined group of one or more instances of a downstream network function, and
alternative configuring means adapted to configure the one or more instances of the initiating network function such that each time when a second initiating transaction different from the first initiating transaction is requested from any of the instances of the initiating network function the respective instance of the initiating network function requests the downstream transaction from an instance of the downstream network function not belonging to the predefined group.

41. The apparatus according to claim 40, wherein the first initiating transaction is different from the second initiating transaction by at least one of an access point name, a subscription information, and a requested quality of service.

42. The apparatus according to claim 40, wherein the predefined group of one or more instances of the downstream network function comprises only one instance.

43. The apparatus according to claim 42, wherein the downstream network function is a policy and charging rules function.

44. The apparatus according to claim 40, wherein the initiating network function resides on a different plane than the downstream network function.

45. Apparatus, comprising:
first selecting means adapted to select a predetermined group of instances of a downstream network function each time when a first initiating transaction is requested from the apparatus;
alternative selecting means adapted to select an alternative instance of the downstream network function not belonging to the predetermined group each time when a second initiating transaction different from the first initiating transaction is requested from the apparatus; and
requesting means adapted to request a downstream transaction from an instance of the predetermined group if the first initiating transaction is requested in order to complete the first initiating transaction and to request the downstream transaction from the alternative instance if the second initiating transaction is requested in order to complete the second initiating transaction.

46. The apparatus according to claim 45, the first initiating transaction is different from the second initiating transaction by at least one of an access point name, a subscription information, and a requested quality of service.

47. The apparatus according to claim 45, wherein the predetermined group of instances of the downstream network function comprises only one instance.

48. The apparatus according to claim 47, wherein the downstream network function is a policy and charging rules function.

49. The apparatus according to claim 45, wherein the downstream network function resides on a different plane than the apparatus.

50. Method, comprising:
configuring one or more instances of an initiating network function such that each time when a first initiating transaction is requested from any of the instances of the initiating network function the respective instance of the initiating network function requests a downstream transaction from an instance of a predefined group of one or more instances of a downstream network function, and
configuring the one or more instances of the initiating network function such that each time when a second initiating transaction different from the first initiating transaction is requested from any of the instances of the initiating network function the respective instance of the initiating network function requests the downstream transaction from an instance of the downstream network function not belonging to the predefined group.

51. The method according to claim 50, wherein the first initiating transaction is different from the second initiating transaction by at least one of an access point name, a subscription information, and a requested quality of service.

52. The method according to claim 50, wherein the predefined group of one or more instances of the downstream network function comprises only one instance.

53. The method according to claim 52, wherein the downstream network function is a policy and charging rules function.

54. The method according to claim 50, wherein the initiating network function resides on a different plane than the downstream network function.

55. Method, comprising:
selecting a predetermined group of instances of a downstream network function each time when a first initiating transaction is requested from an apparatus performing the method;
selecting an alternative instance of the downstream network function not belonging to the predetermined group each time when a second initiating transaction different from the first initiating transaction is requested from the apparatus; and
requesting a downstream transaction from an instance of the predetermined group if the first initiating transaction is requested in order to complete the first initiating transaction and to request the downstream transaction from the alternative instance if the second initiating transaction is requested in order to complete the second initiating transaction.

56. The method according to claim 55, the first initiating transaction is different from the second initiating transaction by at least one of an access point name, a subscription information, and a requested quality of service.

57. The method according to claim 55, wherein the predetermined group of instances of the downstream network function comprises only one instance.

58. The method according to claim 57, wherein the downstream network function is a policy and charging rules function.

59. The method according to claim 55, wherein the downstream network function resides on a different plane than the apparatus.
